(19) United States
(12) Patent Application Publication
(10) Pub. No.: US 2016/0259513 A1
(43) Pub. Date: Sep. 8, 2016

(54) ALARM-POSITION DISPLAY APPARATUS AND ALARM-POSITION DISPLAY METHOD

(71) Applicant: MITSUBISHI ELECTRIC CORPORATION, Chiyoda-ku, Tokyo (JP)

(72) Inventors: Junichi HAMANAKA, Tokyo (JP); Satoru KANETA, Tokyo (JP)

(73) Assignee: Mitsubishi Electric Corporation, Tokyo (JP)

(21) Appl. No.: 14/648,390

(22) PCT Filed: May 30, 2014
(86) PCT No.: PCT/JP2014/064537

§ 371 Date: May 29, 2015

(51) Int. Cl. G06F 3/0485; G05B 19/048; G06F 3/0481

(52) U.S. Cl. CPC G06F 3/0485; G06F 3/04817; G05B 19/048; G05B 2219/14005

(57) ABSTRACT

An alarm-position display apparatus includes a display unit that displays, on a screen, a system configuration of a PLC system, a scroll bar and a scroll bar area, a display-position calculating unit that calculates a display position of the system configuration and calculates a display position of the scroll bar and of the scroll bar area on the screen, an alarm-information processing unit that calculates, when an alarm occurs in the PLC system, an occurrence place of the alarm and a type of the alarm, and a combined-display calculating unit that calculates a display position of an alarm icon corresponding to the occurrence place on the scroll bar area. The display unit displays, on the basis of a calculation result of the combined-display calculating unit, the alarm icon on the scroll bar area in a display system corresponding to the type of the alarm.

### FIELD

The present invention relates to an alarm-position display apparatus and an alarm-position display method.

### BACKGROUND

In a monitoring apparatus such as a PLC (programmable logic controller), for checking where abnormality of an apparatus, warning, or the like has occurred, it is necessary to display, in the monitoring apparatus, the configuration of an entire system and a place where a state abnormality has occurred. For example, in an application for displaying a system configuration in a programmable display, there is a function of displaying, on the programmable display, a system of a connected sequencer.

When an information amount is large when a large configuration is displayed, in some case, it is difficult to realize both of display of all kinds of information in one screen and operability. Therefore, in monitoring apparatuses in recent years, display of information is realized using methods of, for example, (1) displaying a reduced screen on a screen and displaying a system entire configuration and (2) preparing a scroll bar for changing display screen at a screen corner.

Concerning (1) above, because the reduced screen is separately displayed, there is a problem in that display of a conventionally-displayed configuration diagram of the entire system is hidden and also a problem in that operability is deteriorated because the entire system is reduced and displayed. Concerning (2) above, movement of the screen is enabled by preparing the scroll bar. However, because information concerning the entire system is not displayed in the screen, it is necessary to, while moving the scroll bar, search for an apparatus in which abnormality has occurred. For example, an alarm occurrence section is displayed on the scroll bar and the scroll bar is moved to the alarm occurrence section to make it possible to check the alarm occurrence section (see, for example, Patent Literature 1). Further, a switch for movement to an abnormal place is prepared on the scroll bar to realize switching of the screen.

### CITATION LIST

### Patent Literature

Patent Literature 1: Japanese Patent Application Laid-Open No. 2011-185911

### SUMMARY

### Technical Problem

However, according to the related art, a type of abnormality of an apparatus cannot be determined. For example, it cannot be determined whether the abnormality is significant abnormality, insignificant abnormality, or abnormality defined by a user. That is, it cannot be identified what type of abnormality has occurred. Specifically, it cannot be distinguished whether a problem so significant as to stop the entire system has occurred, abnormality has occurred in a unit alone, insignificant abnormality has occurred in the unit alone, or the system is in a state in which an abnormality condition set by the user is met. In this way, according to the related art, if abnormalities occur in a plurality of places, information concerning abnormality of apparatus that is important and requires urgent attention and abnormality that does not require urgent attention cannot be distinguished. Therefore, it is necessary to check all the places in which abnormalities have occurred. Therefore, there is a problem in that the abnormality type cannot be discriminated only by notification of abnormality on the scroll bar and the user cannot quickly check the state of various units in which abnormalities have occurred.

The present invention has been devised in view of the above and it is an object of the present invention to obtain an alarm-position display apparatus and an alarm-position display method capable of displaying, after causing a user to check the configuration of an entire system, state of various units in which abnormalities have occurred in the configuration of the system to enable the user to quickly check the state.

### Solution to Problem

In order to solve the aforementioned problems, an alarm-position display apparatus according to one aspect of the present invention is constructed in such a manner as to include: a display unit that displays, on a screen, a system configuration of a PLC system, a scroll bar of the system configuration on the screen, and a scroll bar area, which is a movable region of the scroll bar; a display-position calculating unit that calculates a display position of the system configuration on the screen, and calculates a display position of the scroll bar on the screen and a display position of the scroll bar area on the screen; an alarm-information processing unit that calculates, when an alarm occurs in the PLC system, an occurrence place of the alarm and a type of the alarm; and a combined-display calculating unit that calculates a display position of an alarm icon corresponding to the occurrence place on the scroll bar area, wherein the display unit displays, on the basis of a calculation result of the combined-display calculating unit, the alarm icon on the scroll bar area in a display system corresponding to the type of the alarm.

### Advantageous Effects of Invention

The alarm-position display apparatus and the alarm-position display method according to the present invention attain an effect that a user can easily identify what type of abnormality has occurred.

### BRIEF DESCRIPTION OF DRAWINGS

FIG. 1 is a diagram showing the configurations of an alarm-position display apparatus and a PLC system according to first and second embodiments of the present invention.

FIG. 2 is a diagram showing a state on a screen of a display unit according to the first embodiment of the present invention.

FIG. 3 is a diagram showing a state on the screen of the display unit according to the first embodiment of the present invention.

FIG. 4 is a diagram showing a state on the screen of the display unit according to the first embodiment of the present invention.

FIG. 5 is a diagram showing a state on the screen of the display unit according to the first embodiment of the present invention.

FIG. 6 is a diagram showing a state on the screen of the display unit according to the first embodiment of the present invention.

FIG. 7 is a diagram showing an operation flowchart of the alarm-position display apparatus according to the first embodiment of the present invention.

FIG. 8 is a diagram showing an operation flowchart of an alarm-position display apparatus according to a second embodiment of the present invention.

FIG. 9 is a diagram showing a state on a screen of a display unit according to the second embodiment of the present invention.

FIG. 10 is a diagram showing a state on the screen of the display unit according to the second embodiment of the present invention.

FIG. 11 is a diagram showing a state on the screen of the display unit according to the second embodiment of the present invention.

FIG. 12 is a diagram showing a state on the screen of the display unit according to the second embodiment of the present invention.

FIG. 13 is a diagram showing a state on the screen of the display unit according to the second embodiment of the present invention.

FIG. 14 is a diagram showing the configurations of an alarm-position display apparatus and a PLC system according to a third embodiment of the present invention.

FIG. 15 is a diagram showing an operation flowchart of the alarm-position display apparatus according to the third embodiment of the present invention.

FIG. 16 is a diagram showing a state on a screen of a display unit according to the third embodiment of the present invention.

FIG. 17 is a diagram showing a state on the screen of the display unit according to the third embodiment of the present invention.

FIG. 18 is a diagram showing a state on the screen of the display unit according to the third embodiment of the present invention.

FIG. 19 is a diagram showing a state on the screen of the display unit according to the third embodiment of the present invention.

FIG. 20 is a diagram showing a state on the screen of the display unit according to the third embodiment of the present invention.

### DESCRIPTION OF EMBODIMENTS

Exemplary embodiments of the present invention are explained in detail below with reference to the drawings. Note that the present invention is not limited by the embodiments.

### First Embodiment

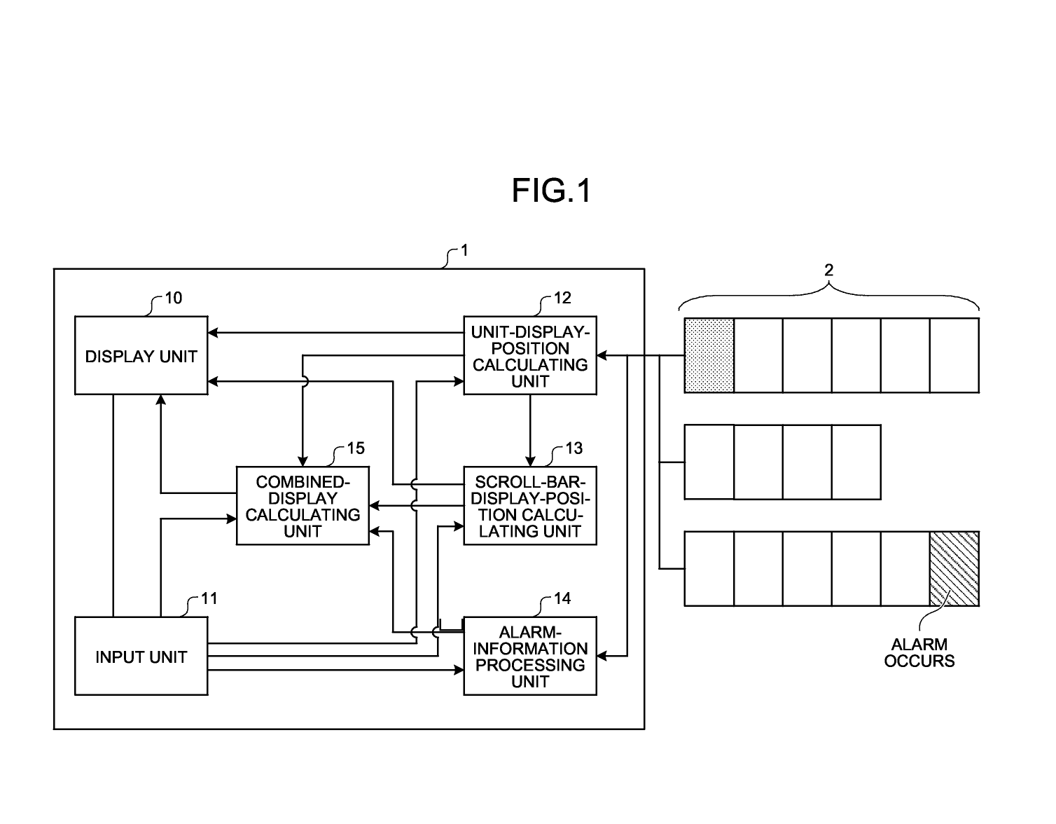

FIG. 1 is a diagram showing the configurations of an alarm-position display apparatus 1 and a PLC system 2 according to a first embodiment of the present invention. The alarm-position display apparatus 1 is, for example, a programmable display. The inside of the alarm-position display apparatus 1 is shown from the view point of functional blocks. The alarm-position display apparatus 1 includes a display unit 10, an input unit 11, a unit-display-position calculating unit 12 and a scroll-bar-display-position calculating unit 13, which are display-position calculating units, an alarm-information processing unit 14, and a combined-display calculating unit 15. Functions of these units are realized by, for example, software executed by the alarm-position display apparatus 1. The display unit 10 that visually provides a user with information and an input unit 11 that receives touch operation and the like of the user are integrated as, for example, a touch panel-type monitor.

The unit-display-position calculating unit 12 executes, according to the configuration of the PLC system 2 and a magnification ratio and a part to be displayed designated by the user from the input unit 11 or the like, coordinate calculation or the like for displaying a part or all of the configuration of the PLC system 2 to be displayed on the display unit 10.

The scroll-bar-display-position calculating unit 13 performs display position calculation for setting, as a scroll bar area, a predetermined region on a screen of the display unit 10. The scroll bar area indicates a movable region of a scroll bar. Further, the scroll-bar-display-position calculating unit 13 performs, on the basis of a user input from the input unit 11 as well, display position calculation for displaying the scroll bar on the scroll bar area. Results of the calculations are sent to the display unit 10 directly or via the combined-display calculating unit 15, and the scroll bar area and the scroll bar are displayed.

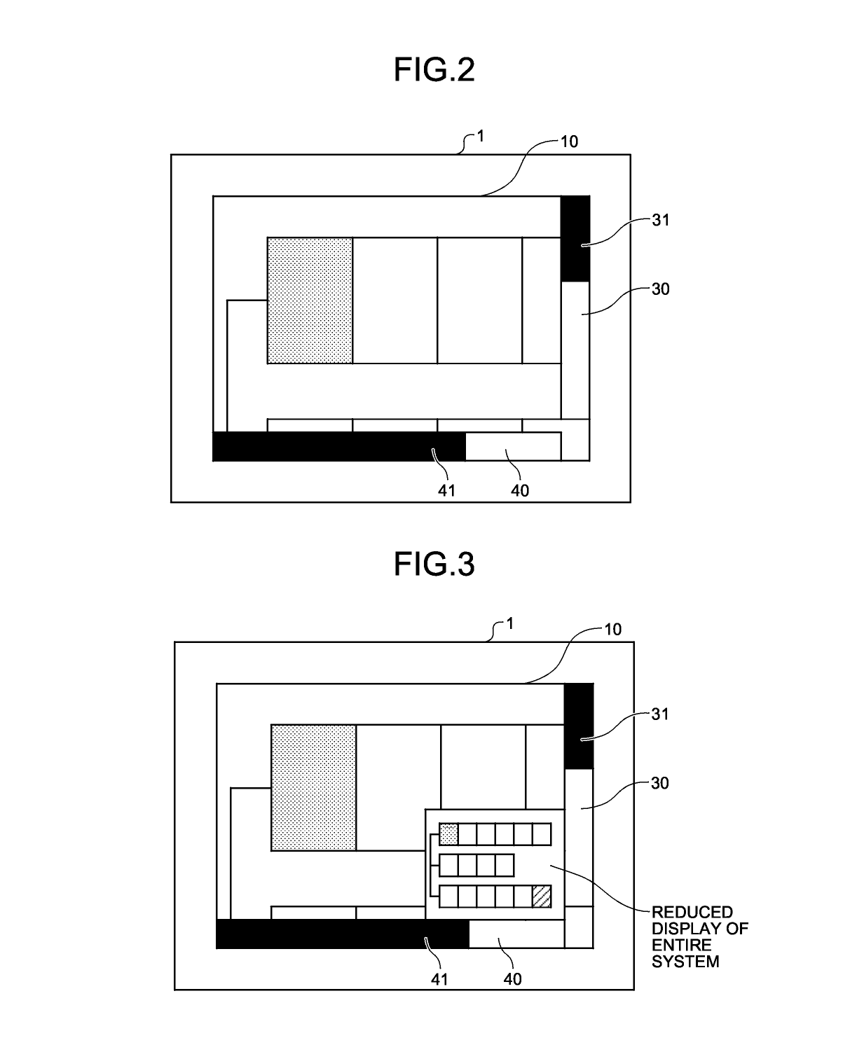

FIG. 2 shows a state on the screen of the display unit 10 at the time when an alarm does not occur. In a system configuration diagram of the PLC system 2 displayed on the display unit 10, a part of apparatuses of the PLC system 2 displayable within limited resolution is displayed. Further, the display unit 10 displays a vertical scroll bar area 30 and a horizontal scroll bar area 40 in vertical and horizontal directions. A vertical scroll bar 31 and a horizontal scroll bar 41 are respectively displayed in the vertical scroll bar area 30 and the horizontal scroll bar area 40.

The user can change a region of the PLC system 2 displayed on the display unit 10 by performing operation of touching, with a finger, the screen of the display unit 10, on which the vertical scroll bar 31 and the horizontal scroll bar 41 are displayed, and continuously sliding and thereafter detaching the finger (hereinafter referred to as flick operation). It can be arranged such that the vertical scroll bar 31 and the horizontal scroll bar 41 move only while the finger touches the screen of the display unit 10 with the flick operation, or such that the user touches the screen with the finger and release the finger when the bar starts to move, and thereafter, the bar visually moves with inertia. The input unit 11 receives the operation on the screen of the display unit 10 by the finger of the user and the like.

The size of the bars of the vertical scroll bar 31 and that of the horizontal scroll bar 41 are calculated by the scroll-bar-display-position calculating unit 13 such that the sizes are changed at a ratio of a region currently displayed on the screen of the display unit 10 with respect to the size of the entire PLC system 2. As the sizes of the bars become larger, the ratio of the region of the PLC system 2 currently displayed on the screen of the display unit 10 becomes larger. Note that the input unit 11 receives user operation, whereby reduced display of the entire PLC system 2 can also be additionally displayed as shown in FIG. 3.

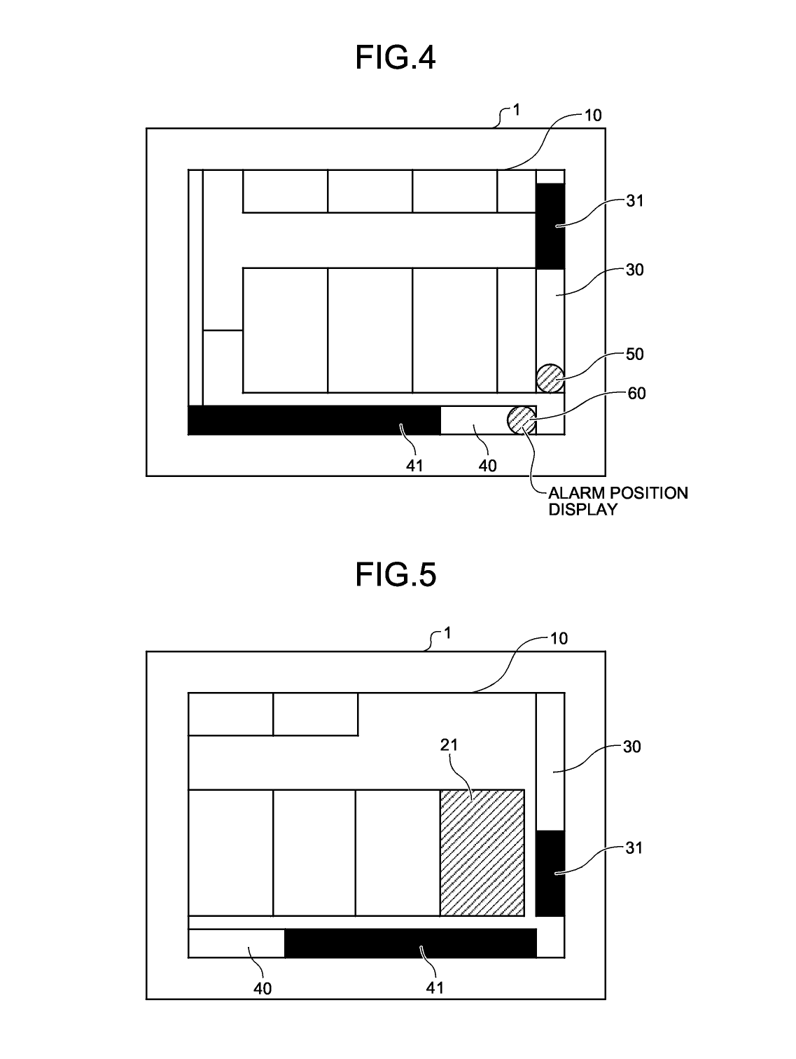

When abnormality occurs in a unit in the PLC system 2, as shown in FIG. 4, alarm icons 50 and 60 or the like for notifying that the unit in which an alarm has occurred is present are displayed on the vertical scroll bar area 30 and the horizontal scroll bar area 40. With the alarm icons 50 and 60, the user can check whether or not the unit in which the abnormality has occurred is present in the PLC system 2. The alarm icons 50 and 60 are displayed on the vertical scroll bar area 30 and the horizontal scroll bar area 40 according to a place of the unit in which the alarm has occurred.

In FIG. 4, the alarm icon 50 is displayed on the vertical scroll bar area 30 and the alarm icon 60 is displayed on the horizontal scroll bar area 40. Because the alarm icons 50 and 60 are not present on the vertical scroll bar 31 and the horizontal scroll bar 41, it is seen that the unit in which the alarm has occurred is not currently displayed on the screen of the display unit 10. When the user flicks the vertical scroll bar 31 downward and flicks the horizontal scroll bar 41 rightward, as shown in FIG. 5, an abnormal unit 21 in which the alarm has occurred is displayed on the screen of the display unit 10.

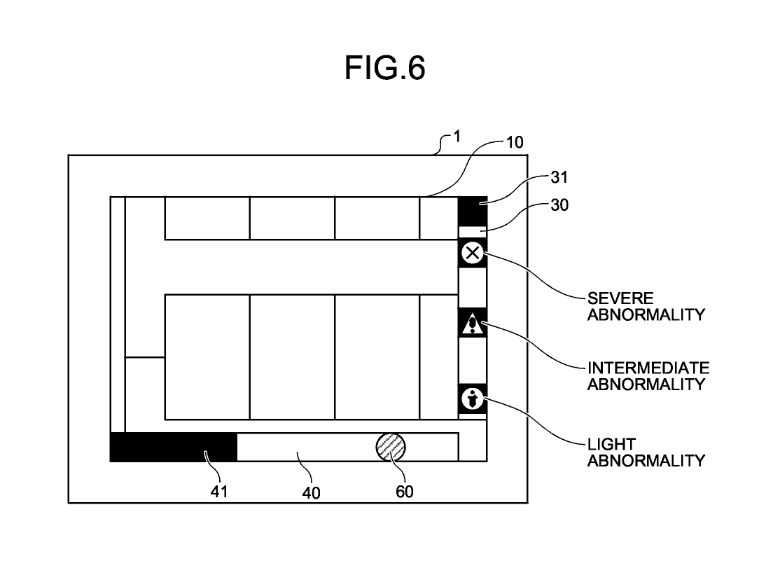

In this embodiment, further, in the alarm notification by the alarm icons on the vertical scroll bar area 30 and the horizontal scroll bar area 40, as shown in FIG. 6, the alarm icons for notifying abnormality are displayed with a type, a color, or the like thereof changed according to a degree of occurred abnormality. Distinguishable display is performed to, for example, display severe abnormality in red, display intermediate abnormality in yellow, and display light abnormality in green. The transmittance of the alarm icons themselves can be changed to display the alarm icons to be overlaid on the vertical scroll bar area 30 and the horizontal scroll bar area 40. FIG. 6 shows an example in the vertical scroll bar area 30. However, when abnormalities of different types such as severe abnormality and light abnormality have occurred in the same place, abnormality with high importance is preferentially displayed on the vertical scroll bar area 30 and the horizontal scroll bar area 40.

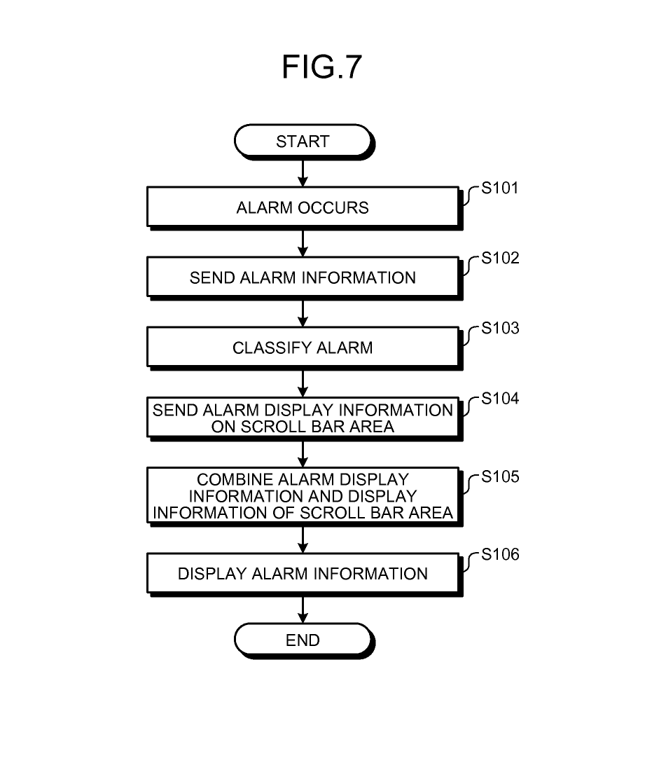

An operation flowchart of the alarm-position display apparatus 1 at this point is shown in FIG. 7. Specifically, when an alarm occurs in the PLC system 2 (step S101), information concerning in which unit the alarm has occurred is sent from the PLC system 2 to the alarm-information processing unit 14 together with information concerning the type of the alarm decided by specifications (step S102). The information concerning the type of the alarm includes, for example, information concerning severe, intermediate, or light abnormality indicating whether the abnormality is severe abnormality or light abnormality and information concerning whether the abnormality is the4 abnormality defined by the user. Specifically, information concerning, for example, whether a problem so significant as to stop the entire PLC system 2 has occurred, abnormality has occurred in a unit alone, light abnormality has occurred in the unit alone, or the PLC system 2 is in a state in which an abnormality condition set by the user is met is conceivable.

The alarm-information processing unit 14 classifies these kinds of information (step S103) and sends a display method for a type, a color, or the like of the alarm icons on the scroll bar area based on the type of the alarm and alarm display information, which is data of a position of an alarm occurrence place, to the combined-display calculating unit 15 (step S104). The combined-display calculating unit 15 combines the alarm display information and the display information of the scroll bar area sent from the scroll-bar-display-position calculating unit 13 (step S105). Thereafter as shown in FIG. 6, the combined-display calculating unit 15 displays, on the scroll bar area corresponding to the alarm occurrence place of the display unit 10, the alarm icons in a form in which the type of the alarm can be distinguished (step S106).

With the alarm-position display apparatus 1 and the alarm-position display method according to this embodiment, it is possible to display the alarm icons such that the user can quickly identify what type of abnormality has occurred.

### Second Embodiment

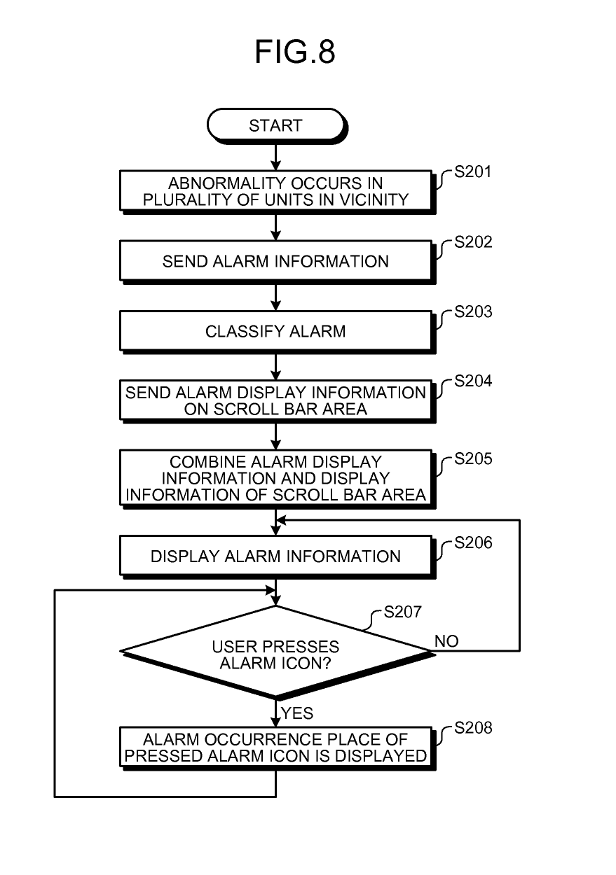

A figure showing the configurations of the alarm-position display apparatus 1 and the PLC system 2 according to the second embodiment of the present invention is the same as FIG. 1. FIG. 8 shows an operation flowchart of the alarm-position display apparatus 1 in this embodiment. In step S201, abnormality has occurred in a plurality of units in the vicinity in the PLC system 2. Alternatively, another abnormality has occurred in a place in a vertical or horizontal position same as or close to a place where the abnormality has occurred. Therefore, a plurality of abnormalities have occurred. Steps S202 to S204 are the same as steps S102 to S104 in the first embodiment. However, the information concerning the type of the alarm explained in the first embodiment does not have to be treated.

In this embodiment, in step S205, when combining the alarm display information and the display information of the scroll bar area sent from the scroll-bar-display-position calculating unit 13, the combined-display calculating unit 15 determines whether overlap of the alarm icons occurs in the scroll bar area. The determination is performed according to whether a difference between coordinates in the vertical direction or a difference between coordinates in the horizontal direction of a plurality of alarm occurrence places is equal to or smaller than a predetermined threshold decided in advance.

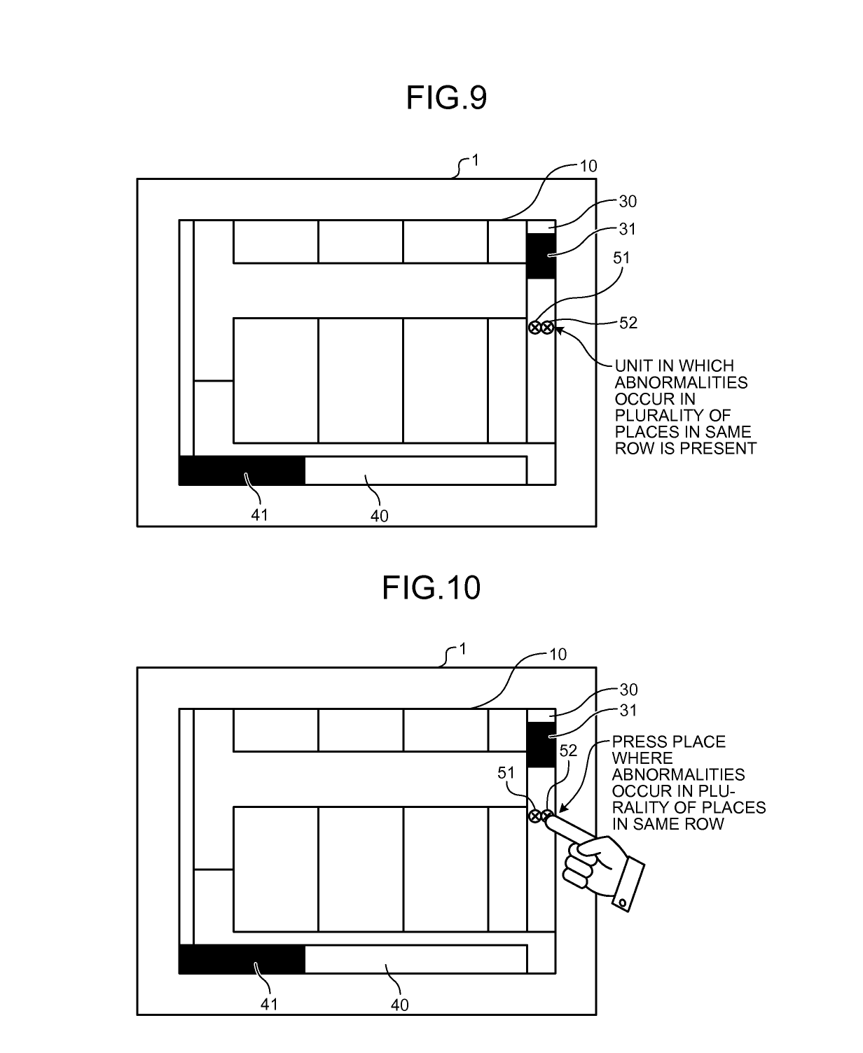

As in step S201, in a case in which abnormality has occurred in a plurality of units in the vicinity within the PLC system 2, or alternatively, in a case in which another abnormality has occurred in a place in a vertical or horizontal position same as or close to a place where the abnormality has occurred and, therefore, a plurality of abnormalities have occurred, in step S205, when combining the alarm display information and the display information of the scroll bar area sent from the scroll-bar-display-position calculating unit 13, the combined-display calculating unit 15 determines that overlap of the alarm icons would occur and determines that the alarm icons should be simultaneously displayed on the vertical scroll bar area 30 or the horizontal scroll bar area 40. As a result, in step S206, for example, as shown in FIG. 9, on the vertical scroll bar area 30, the combined-display calculating unit 15 displays alarm icons 51 and 52, which are sub-icons, in the same row by reducing the ion size of the alarm icons 51 and 52. When abnormalities have occurred in a plurality of places in the vicinity, in the same row (the same position in the vertical direction), or near the same column (the same position in the horizontal direction), by using a type and a color of the icons, characters to be incidentally displayed, and the like, the combined-display calculating unit 15 notifies the user that the abnormalities have occurred in the plurality of places.

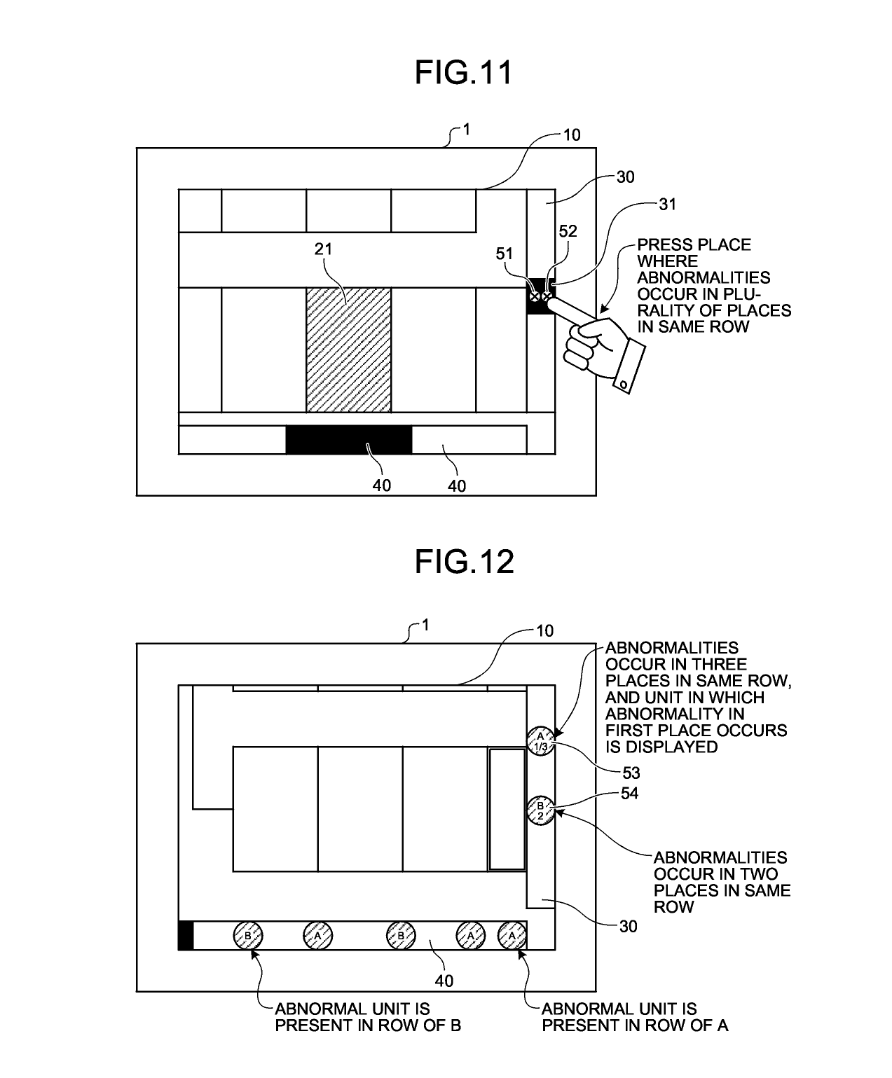

Thereafter, the input unit 11 waits for a user to press the alarm icons 51 and 52 as shown in FIG. 10 (step S207). When either one of the alarm icons 51 and 52 is pressed (Yes in step S207), as shown in FIG. 11, an abnormal unit 21, which is an alarm occurrence place indicated by the pressed alarm icon, is displayed on the display unit 10 (step S208), and the processing returns to step S207. That is, when occurrence of alarms in a plurality of places is notified on the scroll bar area, for example, every time either one of the alarm icons 51 and 52 is pressed (Yes in step S207), the alarm occurrence place indicated by the pressed alarm icon is sequentially switched and displayed on the display unit 10 (step S208). If the user presses none of the alarm icons 51 and 52 (No in step S207), the display shown in FIG. 9 is maintained (step S206).

A display example in step S206 can be the one as shown in FIG. 12. For example, when a plurality of alarms occur in the same row, the alarm icon 53 corresponding to an alarm with high importance is displayed in the vertical scroll bar area 30. The alarm icon 53 indicates with “A1/3” that three alarms have occurred in total in the same row and the alarm icon 53 is an alarm with the highest importance because of the reason that the alarm is severe abnormality. The alarm icon 53 is preferentially displayed. The alarm icon 54 indicates with “B2” that two alarms have occurred in total in the same row. Three alarm icons corresponding to “A” and three alarm icons corresponding to “B” are displayed on the horizontal scroll bar area 40 to respectively correspond to the alarm icons 53 and 54.

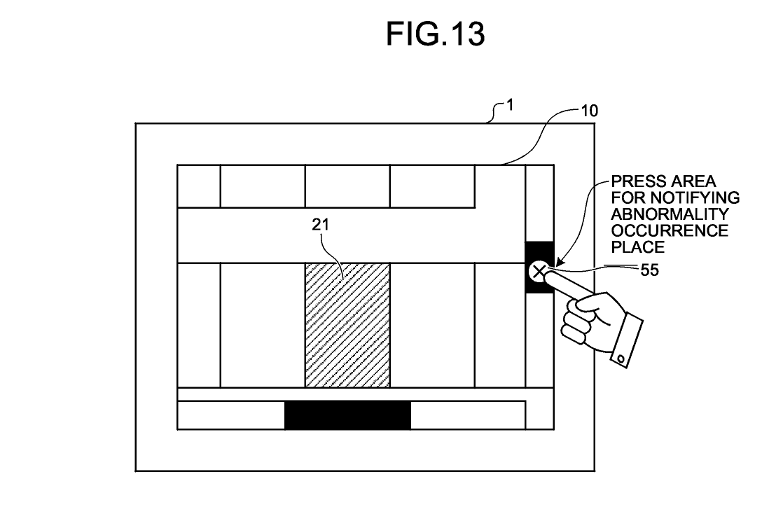

Even when only one alarm occurs in the same row and there is only one alarm icon 55 on the vertical scroll bar area 30 as shown in FIG. 13, if the alarm icon 55 is pressed, as shown in FIG. 13, the place in which an alarm occurrence place indicated by the pressed alarm icon 55 can be displayed on the screen of the display unit 10. When the alarm occurrence place is not displayed on the screen of the display unit 10 before the pressing, the amount of movement in the vertical direction and that in the horizontal direction at the time when the alarm icon 55 is pressed are automatically adjusted.

With the alarm-position display apparatus 1 and the alarm-position display method according to this embodiment, it is possible to solve the problem in that, when a plurality of abnormalities occur in the vicinity of a place where abnormality has occurred or in a place in a vertical or horizontal position same as the place where the abnormality has occurred, the occurrence of the abnormalities cannot be notified. For example, when a system configuration is large, if a plurality of apparatuses in which abnormalities have occurred are present in the vicinity of a place where abnormality has occurred or near a place where an X coordinate value or a Y coordinate value is same as the value in the place where the abnormality has occurred, it is made possible to notify the user to that effect. Further, because it is made possible to notify the user of the fact that abnormalities have occurred in a plurality of places, it is possible to prevent the user from overlooking the occurrence of the abnormalities of the apparatuses.

### Third Embodiment

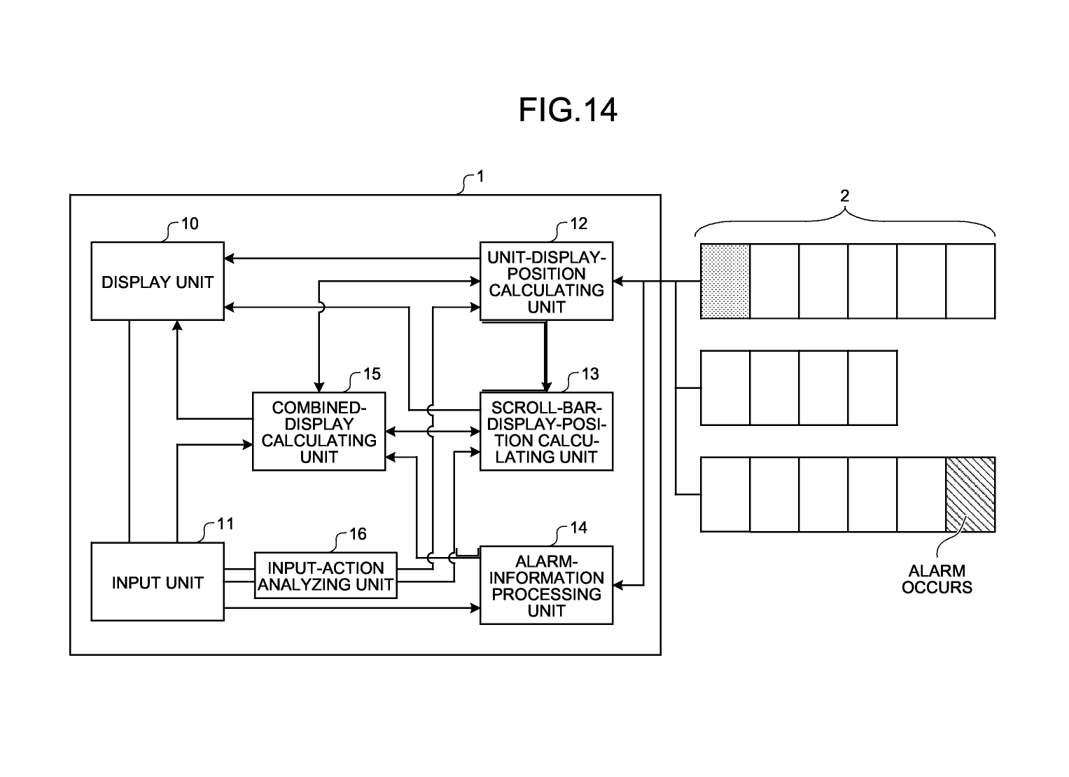

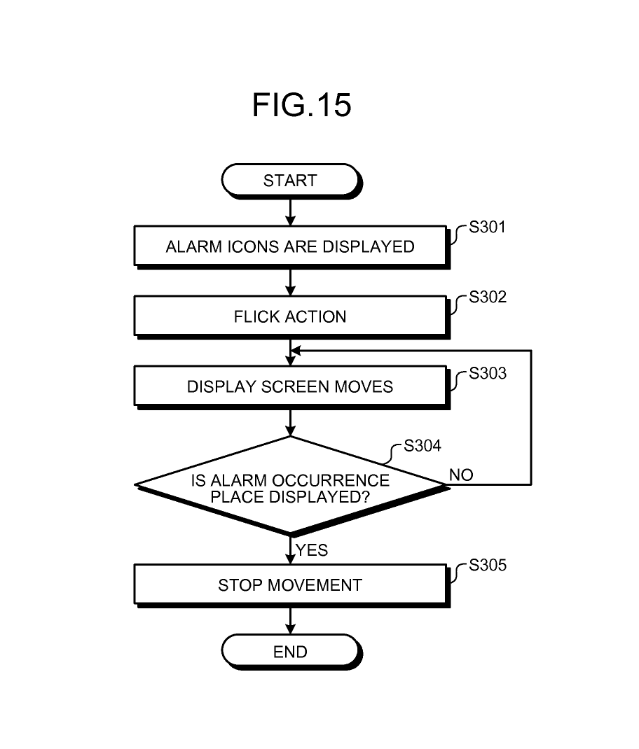

FIG. 14 is a diagram showing the configurations of the alarm-position display apparatus 1 and the PLC system 2 according to a third embodiment of the present invention. In FIG. 14, an input-action analyzing unit 16 is shown in addition to the units shown in FIG. 1. The operations of the other components shown in FIG. 14 are the same as the operations of the components shown in FIG. 1 except for the contents explained below. FIG. 15 shows an operation flowchart of the alarm-position display apparatus 1 in this embodiment.

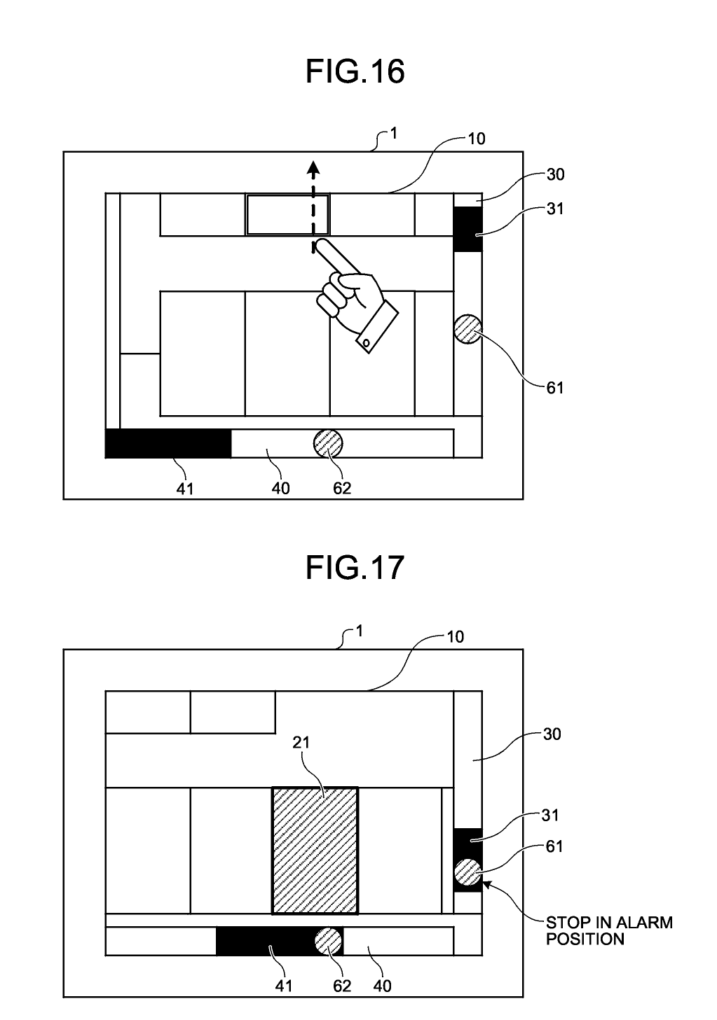

In this embodiment, first, as shown in FIG. 16, an alarm icon 61 is displayed on the vertical scroll bar area 30 on the screen of the display unit 10 and an alarm icon 62 is displayed on the horizontal scroll bar area 40 (step S301). In this state, the alarm icons 61 and 62 are neither present on the vertical scroll bar 31 nor on the horizontal scroll bar 41. Therefore, although a part of a system configuration diagram of the PLC system 2 is displayed, an abnormal unit in which an alarm has occurred is currently not displayed on the screen of the display unit 10. In this state, when a user flicks a portion of the configuration diagram of the PLC system 2 on the screen of the display unit 10 (step S302), the input unit 11 receives the flick. The input-action analyzing unit 16 determines the direction of a contact action by the flick. When the direction of the contact action by the flick is a direction separating away from an abnormal unit, which is an alarm occurrence place, the unit-display-position calculating unit 12 and the scroll-bar-display-position calculating unit 13 execute calculation for moving a display image on the screen of the display unit 10 to approach the abnormal unit, and the display screen moves in that way (step S303). According to the movement, the combined-display calculating unit 15 determines whether or not the alarm occurrence place is displayed (step S304). When the alarm occurrence place is not displayed yet (No in step S304), the movement is continued (step S303). When the abnormal unit 21, which is the alarm occurrence place, is displayed as shown in FIG. 17 (Yes in step S304), the unit-display-position calculating unit 12 and the scroll-bar-display-position calculating unit 13 stop the movement of the display of the display unit 10 (step S305). It can be arranged such that when the abnormal unit 21 in which the alarm has occurred is present in a position deviating from the center on the screen of the display unit 10, the screen movement is stopped in a state in which the abnormal unit 21 is displayed in the center.

As variations of the operation explained above, cases explained below are conceivable.

(Case 1 in which the User Flicks the Portion of the Configuration Diagram of the PLC System)

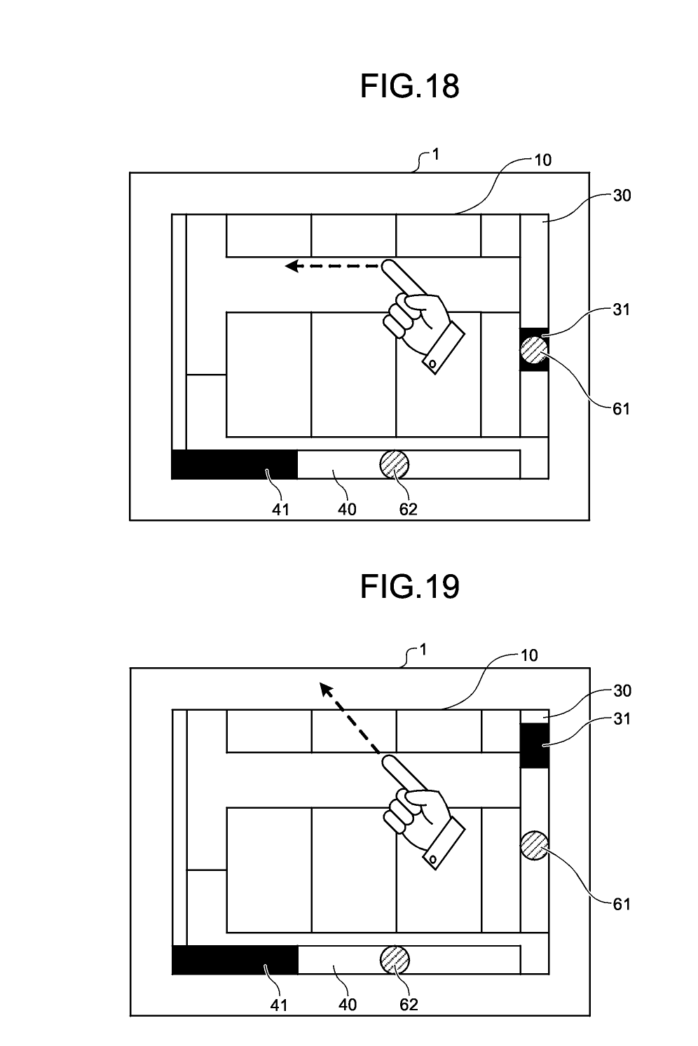

In a display state of the display section 10 shown in FIG. 16, when the user flicks the portion of the configuration diagram of the PLC system 2 upward in the vertical direction (a broken line arrow direction), the display screen moves downward in the vertical direction and the vertical scroll bar 31 moves downward according to the movement of the display screen. At a point in time when the alarm icon 61 is displayed on the vertical scroll bar 31, the screen movement stops as shown in FIG. 18. At this point, the abnormal unit 21 is not displayed on the screen of the display unit 10. Subsequently, as shown in FIG. 18, when the user flicks the portion of the configuration diagram of the PLC system 2 leftward in the horizontal direction (a broken line arrow direction), the display screen moves rightward in the horizontal direction and the horizontal scroll bar 41 moves rightward according to the movement of the display screen. Then the alarm icon 62 is displayed on the horizontal scroll bar 41, and as shown in FIG. 17, the abnormal unit 21 is displayed and the screen movement stops. In this case, the user can flick the portion of the configuration diagram of the PLC system 2 leftward in the horizontal direction first and subsequently flick the portion upward in the vertical direction. At a point in time when the screen movement stops in FIG. 18, when alarms occur in a plurality of places in different positions in the horizontal direction in the same row (the same position in the vertical direction), as explained in the second embodiment, it can be arranged such that the PLC system 2 notifies the user that abnormalities have occurred in a plurality of places. The same applies when alarms occurs in a plurality of places in different positions in the vertical direction in the same row (the same position in the horizontal direction) when the user flicks the portion of the configuration diagram of the PLC system 2 leftward in the horizontal direction first.

(Case 2 in which the User Flicks the Portion of the Configuration Diagram of the PLC System)

In the display state of the display unit 10 shown in FIG. 16, when the user flicks the portion of the configuration diagram of the PLC system 2 upward in the vertical direction (the broken line arrow direction), the display screen moves downward in the vertical direction and the vertical scroll bar 31 moves downward according to the movement of the display screen. At a point in time when the alarm icon 61 is displayed on the vertical scroll bar 31, the screen movement in the vertical direction stops in a state shown in FIG. 18. At this point, the abnormal unit 21 is not displayed on the screen of the display unit 10. However, unlike the case 1, thereafter, even if the user does not perform flick operation, the display screen automatically moves rightward in the horizontal direction and the horizontal scroll bar 41 moves rightward according to the movement of the display screen. Then the alarm icon 62 is displayed on the horizontal scroll bar 41, and the abnormal unit 21 is displayed as shown in FIG. 17. In this case, it can be arranged such that the user flicks the portion of the configuration diagram of the PLC system 2 leftward in the horizontal direction first and thereafter automatically moves the portion in the vertical direction. When the user performs the flick operation again, in the same action, the movement stops in a state in which another abnormal unit in which an alarm has occurred is displayed on the screen.

(Case 3 in which the User Flicks the Portion of the Configuration Diagram of the PLC System)

In a display state of the display unit 10 shown in FIG. 19, when the user flicks the portion of the configuration diagram of the PLC system 2 in a direction (a broken line arrow direction) opposite to a direction in which the abnormal unit 21 is present, the display screen moves in the direction in which the abnormal unit 21 is present and the vertical scroll bar 31 moves downward according to the movement of the display screen. Then, the horizontal scroll bar 41 moves rightward, and the alarm icon 61 is displayed on the vertical scroll bar 31, and the alarm icon 62 is displayed on the horizontal scroll bar 41. Then, the abnormal unit 21 is displayed as shown in FIG. 17. When the user performs the click operation again, in the same action, the movement stops in a state in which another abnormal unit in which an alarm has occurred is displayed on the screen.

(Case in which the User Flicks the Scroll Bar)

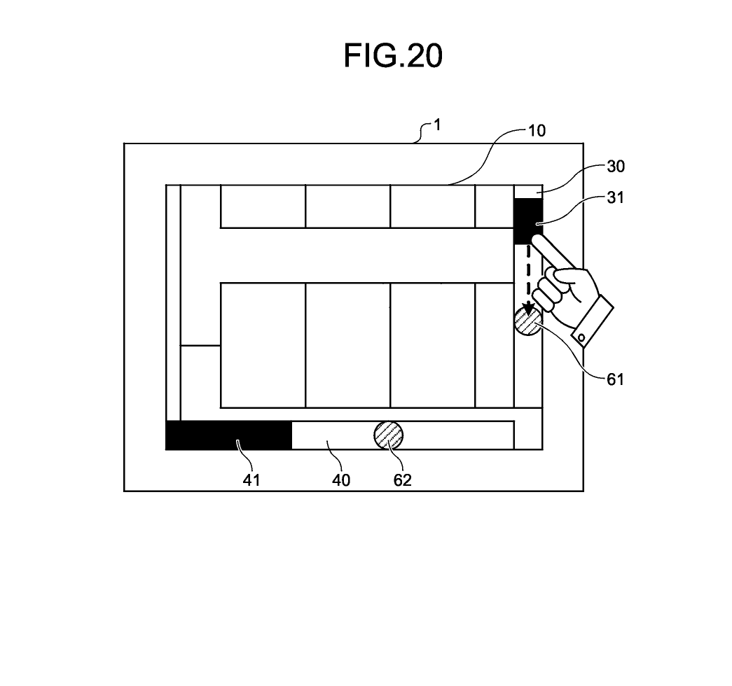

As shown in FIG. 20, as in FIG. 16, the alarm icon 61 is displayed on the vertical scroll bar area 30 on the screen of the display unit 10, the alarm icon 62 is displayed on the horizontal scroll bar area 40, and the alarm icons 61 and 62 are present neither on the vertical scroll bar 31 nor the horizontal scroll bar 41. The user flicks, rather than the portion of the configuration diagram of the PLC system 2, for example, the vertical scroll bar 31 in a direction in which the alarm icon 61 is present (a broken line arrow direction), at a point in time when the alarm icon 61 is displayed on the vertical scroll bar 31, the screen movement stops as shown in FIG. 18. Thereafter, when the user flicks the horizontal scroll bar 41 in a direction in which the alarm icon 62 is present, as shown in FIG. 17, the abnormal unit 21, which is the alarm occurrence place, can be displayed on the screen.

As explained above, according to this embodiment, in the action of stopping the screen movement after the flick in the state in which the abnormal unit 21 is displayed as shown in FIG. 17, the state in which the screen moves to the same row (the same position in the vertical direction) in which the abnormal unit 21 is present as shown in FIG. 18, or the state in which the screen moves to the same row (the same position in the horizontal direction) in which the abnormal unit 21 is present, these modes can be switched by operation by the user from the input unit 11 or the like.

The mode like the action in this embodiment is referred to as, for example, “abnormal unit display stop mode”. A normal mode, which is not the “abnormal unit display stop mode”, is referred to as “normal mode”. For example, in the “normal mode”, when the user performs the flick operation, the screen moves according to the speed (or acceleration) of the movement of a finger by the flick operation and the direction of the movement of the finger. The screen starts the movement at initial speed that depends on the speed (or acceleration) of the movement of the finger. However, the screen gradually decelerates and stops. Therefore, in the “normal mode”, in some case, depending on the initial speed, the screen movement stops before the abnormal unit is displayed and, in other cases, the screen movement does not stop even if the abnormal unit is displayed and the screen movement stops after passing the abnormal unit.

When the user desires to see a state of the configuration of the PLC system 2 to check the type name of each of the units and the operation state of each of the units, the “normal mode” is considered to be desired. Therefore, switching of the “normal mode” and the “abnormal unit display stop mode” can be performed according to selection by the user as explained above. However, the mode can be the “normal mode” when an abnormal unit is absent and an alarm does not occur and can be automatically switched to the “abnormal unit display stop mode” when an alarm occurs. In this case, when the “normal mode” is switched to the “abnormal unit display stop mode”, for example, words such as “an alarm has occurred. Please flick” can be displayed on the screen.

In the “abnormal unit display stop mode”, when a plurality of abnormal units in which alarms have occurred are displayed on the same screen when the screen movement stops, it can be determined that the abnormal units have already been checked, and it can be arranged such that when the next flick operation is performed, the screen is moved to display another abnormal unit not displayed yet.

With the alarm-position display apparatus 1 and the alarm-position display method according to this embodiment, although the scroll bars are used for the screen movement to the alarm occurrence place, it is possible to prevent operability from being deteriorated even if the system configuration increases in size.

In the first to third embodiment, it can be arranged such that in the state in which the abnormal unit 21 is displayed on the screen of the display unit 10, when the user presses the abnormal unit 21 on the screen, detailed information of the abnormality is further displayed on the screen to enable the user to check content of the information.

Note that, in the first to third embodiments, as the functional blocks of the alarm-position display apparatus 1, the unit-display-position calculating unit 12, the scroll-bar-display-position calculating unit 13, the alarm-information processing unit 14, the combined-display calculating unit 15, the input-action analyzing unit 16, and the like are explained. However, the functions of those units are functions realized by a CPU executing software in the alarm-position display apparatus 1 and do not always need to be distinguished in this way.

Further, the present invention is not limited to the embodiments. At an implementation stage, the present invention can be variously modified without departing from the spirit of the present invention. Inventions at various stages are included in the embodiments. Various inventions can be extracted according to appropriate combinations in a disclosed plurality of constituent elements. For example, when the problems described in the technical problem can be solved and the effects described in the advantageous effects of the invention can be obtained even if several constituent elements are deleted from all the constituent elements described in the embodiment, a configuration from which the constituent elements are deleted can be extracted as an invention. Further, the constituent elements described in different embodiments can be combined as appropriate.

### INDUSTRIAL APPLICABILITY

As explained above, the alarm-position display apparatus and the alarm-position display method according to the present invention are useful for grasping abnormality occurrence in the components in the system and, in particular, suitable for a programmable display or the like of a PLC system.

### REFERENCE SIGNS LIST

1 Alarm-position display apparatus
2 PLC system
10 Display unit
11 Input unit
12 Unit-display-position calculating unit
13 Scroll-bar-display-position calculating unit
14 Alarm-information processing unit
15 Combined-display calculating unit
21 Abnormal unit
30 Vertical scroll bar area
31 Vertical scroll bar
40 Horizontal scroll bar area
41 Horizontal scroll bar
50 to 55, 60 to 62 Alarm icons

1. An alarm-position display apparatus comprising:
a display unit that displays, on a screen, a system configuration of a PLC system, a scroll bar of the system configuration on the screen, and a scroll bar area, which is a movable region of the scroll bar;
a display-position calculating unit that calculates a display position of the system configuration on the screen, and calculates a display position of the scroll bar on the screen and a display position of the scroll bar area on the screen;
an alarm-information processing unit that calculates, when an alarm occurs in the PLC system, an occurrence place of the alarm and a type of the alarm; and
a combined-display calculating unit that calculates a display position of an alarm icon corresponding to the occurrence place on the scroll bar area, wherein
the display unit displays, on the basis of a calculation result of the combined-display calculating unit, the alarm icon on the scroll bar area in a display system corresponding to the type of the alarm.

2. An alarm-position display apparatus comprising:
a display unit that displays, on a screen, a system configuration of a PLC system, a scroll bar of the system configuration on the screen, and a scroll bar area, which is a movable region of the scroll bar;
a display-position calculating unit that calculates a display position of the system configuration on the screen and calculates a display position of the scroll bar on the screen and a display position of the scroll bar area on the screen;
an alarm-information processing unit that calculates, when an alarm occurs in the PLC system, an occurrence place of the alarm; and
a combined-display calculating unit that calculates a display position of an alarm icon corresponding to the occurrence place on the scroll bar area, wherein
when a plurality of the alarms occur, the combined-display calculating unit determines whether a difference between positions on the scroll bar area corresponding to a plurality of the occurrence places is equal to or smaller than a predetermined threshold and, when the difference is equal to or smaller than the threshold, the display unit displays, on the scroll bar area, the alarm icon collectively indicating the alarms.

3. The alarm-position display apparatus according to claim 2, wherein
the alarm icon collectively indicating the alarms is a plurality of sub-icons respectively corresponding to the alarms, and
when a user presses the sub-icon, the display unit displays the occurrence place of the alarm corresponding to the pressed sub-icon.

4. An alarm-position display apparatus comprising:
a display unit that displays, on a screen, a system configuration of a PLC system, a scroll bar of the system configuration on the screen, and a scroll bar area, which is a movable region of the scroll bar;
a display-position calculating unit that calculates a display position of the system configuration on the screen and calculates a display position of the scroll bar on the screen and a display position of the scroll bar area on the screen;
an alarm-information processing unit that calculates, when an alarm occurs in the PLC system, an occurrence place of the alarm;
a combined-display calculating unit that calculates a display position of an alarm icon corresponding to the occurrence place on the scroll bar area; and
an input unit that receives a contact action of a user on the screen, wherein
when the input unit receives the contact action when the screen displays a part of the system configuration and does not display the occurrence place, the display unit moves the display of the system configuration on the screen in a direction toward the occurrence place and stops the movement in a state in which the screen displays the occurrence place.

5. An alarm-position display method in a display unit that displays, on a screen, a system configuration of a PLC system, a scroll bar of the system configuration on the screen, and a scroll bar area, which is a movable region of the scroll bar, the alarm-position display method comprising:
a first calculating of a display position of the system configuration on the screen, and calculating of a display position of the scroll bar on the screen and a display position of the scroll bar area on the screen;
a second calculating of, when an alarm occurs in the PLC system, an occurrence place of the alarm and a type of the alarm;
a third calculating of a display position of an alarm icon corresponding to the occurrence place on the scroll bar area; and
displaying of, on the basis of a calculation result of the third step, the alarm icon on the scroll bar area in a display system corresponding to the type of the alarm.

6. An alarm-position display method in a display unit that displays, on a screen, a system configuration of a PLC system, a scroll bar of the system configuration on the screen, and a scroll bar area, which is a movable region of the scroll bar, the alarm-position display method comprising:
a first calculating of a display position of the system configuration on the screen and calculating of a display position of the scroll bar on the screen and a display position of the scroll bar area on the screen;
a second calculating of, when an alarm occurs in the PLC system, an occurrence place of the alarm;
a third calculating of a display position of an alarm icon corresponding to the occurrence place on the scroll bar area; and
determining of, when a plurality of the alarms occur, whether a difference between positions on the scroll bar area corresponding to a plurality of the occurrence places is equal to or smaller than a predetermined threshold and, when the difference is equal to or smaller than the threshold, displaying, in the display position calculated in the third calculating on the scroll bar area, the alarm icon collectively indicating the alarms.

7. The alarm-position display method according to claim 6, wherein
the alarm icon collectively indicating the alarms is a plurality of sub-icons respectively corresponding to the alarms, and
when a user presses the sub-icon, the occurrence place of the alarm corresponding to the pressed sub-icon is displayed on the display unit.

8. An alarm-position display method in a display unit that displays, on a screen, a system configuration of a PLC system, a scroll bar of the system configuration on the screen, and a scroll bar area, which is a movable region of the scroll bar, the alarm-position display method comprising:
a first calculating of a display position of the system configuration on the screen and calculating a display position of the scroll bar on the screen and a display position of the scroll bar area on the screen;
a second calculating of, when an alarm occurs in the PLC system, an occurrence place of the alarm;
a third calculating of a display position of an alarm icon corresponding to the occurrence place on the scroll bar area; and
moving of, when a contact action of a user on the screen is received when the screen displays a part of the system configuration and does not display the occurrence place, the display of the system configuration on the screen in a direction toward the occurrence place and stopping the movement in a state in which the screen displays the occurrence place.
